(19) United States
(12) Patent Application Publication
(10) Pub. No.: US 2014/0179512 A1
(43) Pub. Date: Jun. 26, 2014

(54) PHOTOCATALYST FOR THE PRODUCTION OF HYDROGEN

(71) Applicant: SUNPOWER TECHNOLOGIES LLC, San Marcos, CA (US)

(72) Inventor: Daniel LANDRY, Redondo Beach, CA (US)

(73) Assignee: SUNPOWER TECHNOLOGIES LLC, San Marcos, CA (US)

(21) Appl. No.: 13/722,411

(22) Filed: Dec. 20, 2012

(51) Int. Cl. B01J 27/057

(52) U.S. Cl. CPC B01J 27/0573
USPC 502/1

(57) ABSTRACT

A method and composition for making photocatalytic capped colloidal nanocrystals include semiconductor nanocrystals and inorganic capping agents as photocatalysts. The photocatalytic capped colloidal nanocrystals may be deposited on a substrate and treated to form a photoactive material that may be used in a plurality of photocatalytic energy conversion applications such as water splitting. By combining different semiconductor materials for photocatalytic capped colloidal nanocrystals employed and by changing the semiconductor nanocrystals shapes and sizes, band gaps can be tuned to expand the range of wavelengths of sunlight usable by the photoactive material. The disclosed photocatalytic capped colloidal nanocrystals within the photoactive material may also exhibit a higher efficiency of solar energy conversion process derived from a higher surface area of the semiconductor nanocrystals within photocatalytic capped colloidal nanocrystals available for the absorption of sunlight and enhancement of charge carrier dynamics.

### BACKGROUND

1. Technical Field

The present disclosure relates to photoactive materials employed in energy conversion applications. In particular, the present disclosure relates to compositions and methods to form photocatalytic capped colloidal nanocrystals.

2. Background

Global warming as a result of the accumulation of greenhouse gases such as CO₂ is not a new concept. Nowadays, renewable energy only constitutes a very small fraction of the total world energy mix. On the other hand, oil fuels constitute a non-renewable, finite resource. This profile would have to switch to an energy mix that takes into account renewable energy if CO₂ emissions are to be capped at environmentally safe levels.

Solar energy constitutes the largest renewable carbon-free resource amongst all other renewable energy options, and may help to reduce environmental issues. Nevertheless, current methods to extract energy from the sun have failed to comply with renewable energy requirements, since efficiency of solar energy extraction ranges around 5%.

The global impact of solar energy, either in the form of electricity or solar fuels, depends on the future development of efficient light conversion technologies suitable for massive scale-up. The cost arguments and device dimensions put stringent requirements on the materials suitable for large scale deployment of solar energy technologies. For example, it is very unlikely that single-crystal wafers may be widely used in future solar farms and photosynthetic plants. As a plausible alternative, micro and nanoscale semiconductors can be used as the building blocks for photovoltaic and photocatalytic systems. The bottom-up engineering of functional materials has seen tremendous developments in the past decade, with novel synthetic strategies discovered for a range of technologically important semiconductors. As the emerging class of materials, nanostructured semiconductors offer exciting pathways for tailoring the materials properties through size/shape engineering, quantum size effects, compositional flexibility and controllable formation of multicomponent structures. Given the fact that nanomaterial surfaces may be coordinated with targeted molecular species, the nanostructures easily form stable colloidal solutions, convenient for materials processing and roll-to-roll fabrication of large-area devices.

Precisely engineered nano-assemblies may open up interesting opportunities for solar technologies. Surface modification of nanosized catalysts may affect redox potentials, and may be used to enhance the efficiency of charge carrier dynamics. Furthermore, the problem of poor charge carrier transport in some bulk materials can be significantly alleviated on nanoscale, as the distance that photogenerated carriers have to travel to reach the surface is significantly decreased. Nanoscale semiconductor compositions provide the opportunity to combine useful attributes of two or more materials within a single composite or to generate entirely new properties as a result of the intermixing of two or more materials.

Effectiveness of nanostructured materials is determined to a great extent by the semiconductor's capability of absorbing visible and infrared light, in addition to the requirement of a large surface area that may facilitate more efficient carrier dynamics. Additionally, switching from bulk materials to nanostructures introduces new challenges, such as the increased role of interfaces. Previous research mostly has focused on optimization of the nano-components in nanoscale semiconductors as less attention has been directed towards the efficiency of electronic transport within or between individual nanostructures. Nanostructured TiO₂ has emerged as a suitable photocatalyst that plays a key role in a variety of solar-driven clean energy technologies. Unfortunately, TiO₂ has a band gap of 3 eV, so less than 3-4% of sunlight can be used, resulting in an inefficient process from an economic standpoint. Other semiconductor photocatalytic materials have been studied, whereas limited absorption of solar radiation and low charge carrier dynamics have not yet been overcome.

### SUMMARY

According to various embodiments, a composition and method for making photocatalytic capped colloidal nanocrystals that may be used as a photoactive material in energy conversion applications are disclosed. The method may include semiconductor nanocrystals capped with inorganic capping agents in order to form a photocatalytic capped colloidal nanocrystal composition that may be deposited on a substrate and treated to produce a solid matrix of photoactive material. The photoactive material may be employed in the presence of sunlight and water to initiate redox reactions that may split water into hydrogen and oxygen.

The method for producing photocatalytic capped colloidal nanocrystals may include semiconductor nanocrystals synthesis and substituting organic capping agents with inorganic capping agents. To synthesize semiconductor nanocrystals, a semiconductor nanocrystal precursor and an organic solvent may react to produce organic capped semiconductor nanocrystals. In order to substitute organic capping agents with inorganic capping agents, the inorganic capping agent may be dissolved in a polar solvent, a first solvent, while the organic capped semiconductor nanocrystals may be dissolved in an immiscible, generally non-polar solvent, a second solvent. These two solutions are then combined in a single reaction vessel. The semiconductor nanocrystal reacts with the inorganic capping agent at or near the solvent boundary, the region where the two solvents meet, and a portion of the organic capping agent is replaced with the inorganic capping agent. That is, the inorganic capping agent may displace an organic capping agent from a surface of the semiconductor nanocrystal and the inorganic capping agent may bind to the surface of the semiconductor nanocrystal. The process continues until an equilibrium is established between the inorganic capping agent on a semiconductor nanocrystal and the free inorganic capping agent. The semiconductor nanocrystals obtained after the capping agents exchange may be stable for a few days, after which photocatalytic capped colloidal nanocrystals may precipitate out of the solution.

According to an embodiment, the photocatalytic capped colloidal nanocrystals composition may be deposited on a substrate as thin or bulk films by a variety of techniques with short or long range ordering of photocatalytic capped colloidal nanocrystals. Additionally, the deposited photocatalytic capped colloidal nanocrystals composition can be thermally treated to anneal and form inorganic matrices with embedded photocatalytic capped colloidal nanocrystals. The annealed composition can have ordered arrays of photocatalytic capped colloidal nanocrystals in a solid state matrix, forming a photoactive material that may be used to split water in presence of sunlight. An effect of employing the methods of fabrication and deposition of the present disclosure may be the cost efficiency achieved due to low temperature requirements during semiconductor nanocrystals synthesis and inorganic capping of semiconductor nanocrystals, and simple/low cost methods of deposition.

In another embodiment, deposition on a substrate may not be needed. Accordingly, the photocatalytic capped colloidal nanocrystals composition may be deposited into a crucible to be then annealed and subsequently ground into particles and sintered together to form the photoactive material that may be deposited on a surface where the photoactive material may adhere. In another embodiment, ground particles of photocatalytic capped colloidal nanocrystals may be used directly as a photoactive material.

According to various embodiments, the disclosed photocatalytic capped colloidal nanocrystals in the photoactive material may include different configurations, such as spherical, tetrapod, core/shell, graphene, carbon nanotubes, nanorods, and nanodendritic among others. Varying the configuration of photocatalytic capped colloidal nanocrystals may be achieved by changing the reaction time, reaction temperature profile, or structure of organic capping agents to passivate the surface of semiconductor nanocrystals during growth. In addition, the chemistry of the organic or inorganic capping agents may control several system parameters, such as the growth rate, the shape, and the dispersibility of semiconductor nanocrystals in the solvents, and even the excited state lifetimes of charge carriers in semiconductor nanocrystals.

Materials of the semiconductor nanocrystals within the photocatalytic capped colloidal nanocrystals may be selected in accordance with the irradiation wavelength. Changing the materials and shapes of semiconductor nanocrystals may enable tuning of the band-gap and band-offsets to expand the range of wavelengths usable by the photoactive material. Absorbance wavelengths and enhancement of carrier dynamics may also be increased due to high surface areas of the semiconductor nanocrystals. The photoactive material of the present disclosure may exhibit a band gap lower than 2.8 eV.

The photoactive material may be submerged in water contained in a reaction vessel so that a water splitting process may take place. The structure of the inorganic capping agents of the photocatalytic capped colloidal nanocrystals in the photoactive material may speed up the reaction by quickly transferring charge carriers sent by semiconductor nanocrystals to water. In addition, there may be a higher production of electrons and holes being used in redox reactions, since photocatalytic capped colloidal nanocrystals in the photocatalytic material can be designed to separate holes and electrons immediately upon formation, thus reducing the probability of electrons and holes recombining which would reduce availability in the reactions. Consequently, the redox reaction and water splitting process may occur at a faster and more efficient rate.

### BRIEF DESCRIPTION OF THE DRAWINGS

Embodiments of the present invention are described by way of example with reference to the accompanying figures, which are schematic and are not intended to be drawn to scale. Unless indicated as representing the prior art, the figures represent aspects of the invention.

FIG. 1 is a flow diagram of a method for forming a composition of photocatalytic capped colloidal nanocrystals.

FIG. 2 shows an illustrative embodiment of a spherical configuration of photocatalytic capped colloidal nanocrystals.

FIG. 3 shows an illustrative embodiment of a tetrapod configuration of photocatalytic capped colloidal nanocrystals.

FIG. 4 depicts an illustrative embodiment of a core/shell configuration of photocatalytic capped colloidal nanocrystals.

FIG. 5 shows an illustrative embodiment of a graphene configuration of photocatalytic capped colloidal nanocrystals including graphene oxide (GO).

FIG. 6 shows an illustrative embodiment of a carbon nanotubes configuration of photocatalytic capped colloidal nanocrystals

FIG. 7 depicts an illustrative embodiment of a nanorod configuration of photocatalytic capped colloidal nanocrystals.

FIG. 8 depicts an illustrative embodiment of a koosh nanoball configuration of photocatalytic capped colloidal nanocrystals.

FIG. 9 shows spraying deposition method and an annealing method used to apply and treat photocatalytic capped colloidal nanocrystals on a substrate.

FIG. 10 illustrates a photoactive material employed in the present disclosure.

FIG. 11 depicts an embodiment of charge separation process that may occur during water splitting process using photoactive material containing photocatalytic capped colloidal nanocrystals.

FIG. 12 depicts a method for synthesizing CdTe tetrapods according to another embodiment for method for forming composition, whereby semiconductor nanocrystals in tetrapod configuration may be formed.

FIG. 13 a method for synthesizing CdS nanorods according to another embodiment of method for forming composition, whereby semiconductor nanocrystals in nanorod configuration may be formed.

FIG. 14 is a method for forming CdSe/ZnS.Sn2S6 according to another embodiment of method for forming composition, whereby photocatalytic capped colloidal nanocrystals may be formed.

### DETAILED DESCRIPTION

### Definitions

As used here, the following terms have the following definitions:

“Semiconductor nanocrystals” refers to particles sized between about 1 and about 100 nanometers made of semiconducting materials.

“Electron-hole pairs” refers to charge carriers that are created when an electron acquires energy sufficient to move from a valence band to a conduction band and creates a free hole in the valence band, thus starting a process of charge separation.

“Inorganic capping agent” refers to semiconductor particles that cap semiconductor nanocrystals.

“Photoactive material” refers to a substance that may be used in photocatalytic processes for absorbing light and starting a chemical reaction with light.

“Nanocrystal growth” refers to a synthetic process including the reaction of component precursors of a semiconductor nanocrystal in the presence of a stabilizing organic ligand.

“Branched” refers to segments grown onto a semiconductor nanocrystal face or branch in a non linear alignment with the semiconductor nanocrystal face or branch.

“Heteroaggregate” refers to a combination of at least two elements chemically bonded but not alloyed with each other.

“Segment” refers to a part of a semiconductor nanocrystal material extending longitudinally at an angle from the surface of a photocatalytic capped colloidal nanocrystal.

“Heterostructure” refers to structures that have one semiconductor material grown into the crystal lattice of another semiconductor material.

“Nanorods” refers to any linear nanostructure, such as in the segment of a tetrapod semiconductor nanocrystal or any other type of nanoparticle.

“Polymorphism” refers to a phenomenon which occurs whenever a given chemical compound exists in more than one structural form or arrangement.

“To cap” refers to cover the top or end of a semiconductor nanocrystal with a capping agent.

### Method for Forming Composition of Photocatalytic Capped Colloidal Nanocrystals

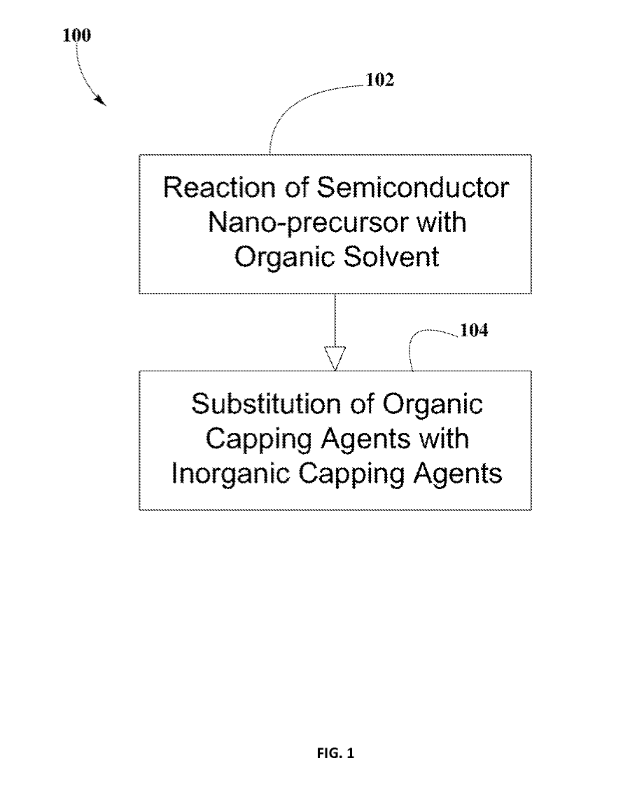

FIG. 1 is a flow diagram of method 100 for forming composition of photocatalytic capped colloidal nanocrystals according to an embodiment. Photocatalytic capped colloidal nanocrystals may be synthesized following accepted protocols known to those with skill in the art, and may include one or more semiconductor nanocrystals and one or more inorganic capping agents.

To synthesize photocatalytic capped colloidal nanocrystals, semiconductor nanocrystals are first grown, by reacting semiconductor nanocrystal precursors in the presence of an organic solvent 102. Here, the organic solvent may be a stabilizing organic ligand, referred in this description as an organic capping agent. Semiconductor nanocrystals may be synthesized in order to produce semiconductor nanocrystals with organic capping agents. One example of an organic capping agent may be trioctylphosphine oxide (TOPO), which may be used in the manufacture of CdSe, among other semiconductor nanocrystals. TOPO 99% may be obtained from Sigma-Aldrich (St. Louis, Mo.). TOPO capping agent prevents the agglomeration of semiconductor nanocrystals during and after the synthesis of semiconductor nanocrystals. Additionally, the long organic chains radiating from organic capping agents on the surface of semiconductor nanocrystals may assist in the suspension and/or solubility of semiconductor nanocrystals in a solvent. Other suitable organic capping agents may include long-chain aliphatic amines, long-chain aliphatic phosphines, long-chain aliphatic carboxylic acids, long-chain aliphatic phosphonic acids and mixtures thereof.

Examples of semiconductor nanocrystals applicable here may include AlN, AlP, AlAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, Culn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, and mixtures thereof. Examples of applicable semiconductor nanocrystals may include core/shell semiconductor nanocrystals like Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O₄, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods like CdSe, core/shell nanorods like CdSe/CdS; nano-tetrapods like CdTe, and core/shell nano-tetrapods like CdSe/CdS.

The chemistry of capping agents may control several system parameters. For example, varying the size of semiconductor nanocrystals may often be achieved by changing the reaction time, reaction temperature profile, or structure of the organic capping agent used to passivate the surface of semiconductor nanocrystals during growth. Other factors may include growth rate or shape, the dispersability in various solvents and solids, and even the excited state lifetimes of charge carriers in semiconductor nanocrystals. The flexibility of synthesis is demonstrated by the fact that often one capping agent may be chosen for its growth control properties, and then later a different capping agent may be substituted to provide a more suitable interface or to modify optical properties—or charge carrier. As know in the art, a number synthetic routes for growing semiconductor nanocrystals may be employed, such as a colloidal route, as well as high-temperature and high-pressure autoclave-based methods. In addition, traditional routes using high temperature solid state reactions and template-assisted synthetic methods may be used.

The morphologies of semiconductor nanocrystals may include nanocrystals, nanorods, nanoplates, nanowires, dumbbell-like nanoparticles, and dendritic nanomaterials. Each morphology may include an additional variety of shapes such as spheres, cubes, tetrahedra (tetrapods), and the like. Neither the morphology nor the size of semiconductor nanocrystals inhibits method 100; rather, the selection of morphology and size of semiconductor nanocrystals may permit the tuning and control of the properties of photocatalytic capped colloidal nanocrystals.

Additionally, seeking to modify optical properties as well as to enhance charge carriers mobility, semiconductor nanocrystals may be capped by inorganic capping agents in polar solvents instead of organic capping agents. In those embodiments, inorganic capping agents may act as photocatalysts to facilitate a photocatalytic reaction on the surface of semiconductor nanocrystals. Optionally, semiconductor nanocrystals may be modified by the addition of not one but two different inorganic capping agents. In that instance, a reduction inorganic capping agent is first employed to facilitate the reduction half-cell reaction; then, an oxidation inorganic capping agent facilitates the oxidation half-cell reaction.

Inorganic capping agents may take many forms. In some embodiments these agents may be neutral or ionic, or they may be discrete species, either linear or branched chains, or two-dimensional sheets. Ionic inorganic capping agents are commonly referred to as salts, pairing a cation and an anion. The portion of the salt specifically referred to as an inorganic capping agent is the ion that displaces the organic capping agent.

Additionally, method 100 involves substitution of organic capping agents with inorganic capping agents 104. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction rapidly produces insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, while organic capped semiconductor nanocrystals may be dissolved in an immiscible, generally non-polar, solvent. These two solutions may then be combined and stirred for about 10 minutes, after which a complete transfer of semiconductor nanocrystals from the non-polar solvent to the polar solvent may be observed. Immiscible solvents may facilitate a rapid and complete exchange of organic capping agents with inorganic capping agents.

Organic capped semiconductor nanocrystals may react with inorganic capping agents at or near the solvent mixture boundary, the region where the two, organic and inorganic, solvents meet, where a portion of organic capping agents may be exchanged/replaced with inorganic capping agents. That is, inorganic capping agents may displace organic capping agents from a surface of semiconductor nanocrystals and consequently bind to the surface of semiconductor nanocrystals. The process continues until an equilibrium may be established between inorganic capping agents on the surface of semiconductor nanocrystals and the free inorganic capping agents. Preferably, the equilibrium favors inorganic capping agents on semiconductor nanocrystals. All the above described steps may be carried out under a nitrogen environment inside a glove box.

Examples of polar solvents may include 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, water, and mixtures thereof.

Polar solvents such as spectroscopy grade FA, and DMSO, anhydrous, 99.9%, may be supplied by Sigma-Aldrich. Suitable colloidal stability of semiconductor nanocrystals dispersions is mainly determined by the solvent dielectric constant, which may range between about 106 to about 47, with 106 being preferred.

The purification of inorganic capped semiconductor nanocrystals may require an isolation procedure, such as the precipitation of inorganic product. That precipitation permits one of ordinary skill to wash impurities and/or unreacted materials out of the precipitate. Such isolation may allow for the selective application of photocatalytic capped colloidal nanocrystals.

Preferred inorganic capping agents for photocatalytic capped colloidal nanocrystals may include polyoxometalates and oxometalates, such as tungsten oxide, iron oxide, gallium zinc nitride oxide, bismuth vanadium oxide, zinc oxide, and titanium dioxide, among others. Inorganic capping agents may include metals selected from transition metals and

Another possible inorganic capping agent may be Zintl ions. As used, Zintl ions may refer to homopolyatomic anions and heteropolyatomic anions that may have intermetallic bonds between the same or different metals of the main group, transition metals, lanthanides, and/or actinides. Examples of Zintl ions may include As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi 33-, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻Sb₄²⁻, Sb₇³⁻, SbSe₄³⁻, SbSe₄⁵⁻, SbTe₄⁵⁻Sb₂Se₃⁻, Sb₂Te₅⁴⁻, Sb₂Te₇⁴⁻, Sb₄Te₄⁴⁻, Sb₉Te₆³⁻Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, mixed metal SnS₄Mn₂⁵⁻, and the like. The positively charged counter ions may be alkali metal ions, ammonium, hydrazinium, tetraalkylammmonium, and the like.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe. Still further, inorganic capping agents may include mixtures of Zintl ions and molecular compounds. These inorganic capping agents further may include transition metal chalcogenides, examples of which may include the tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, such as MoS(Se₄)₂²⁻, Mo₂S₆²⁻, and the like.

Method 100 may be adapted to produce a wide variety of photocatalytic capped colloidal nanocrystals. Adaptations of this method 100 may include adding two different inorganic capping agents to a single semiconductor nanocrystals (e.g., Au.(Sn₂S₆;In₂Se₄); Cu₂Se.(In₂Se₄;Ga₂Se₃)), adding two different semiconductor nanocrystals to a single inorganic capping agent (e.g., (Au;CdSe).Sn₂S₆; (Cu₂Se;ZnS).Sn₂S₆), adding two different semiconductor nanocrystals to two different inorganic capping agents (e.g., (Au;CdSe).(Sn₂S₆;In₂Se₄)), and/or additional multiplicities.

The sequential addition of inorganic capping agents to semiconductor nanocrystals may be possible under the disclosed method 100. Depending, for example, upon concentration, nucleophilicity, bond strength between capping agents and semiconductor nanocrystal, and bond strength between semiconductor nanocrystal face dependent capping agent and semiconductor nanocrystal, inorganic capping of semiconductor nanocrystals may be manipulated to yield other combinations.

Suitable photocatalytic capped colloidal nanocrystals may include Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

As used here the denotation Au.Sn₂S₆ may refer to an Au semiconductor nanocrystal capped with a Sn₂S₆ inorganic capping agent. Charges on the inorganic capping agent are omitted for clarity. This notation [semiconductor nanocrystal].[inorganic capping agent] is used throughout this description. The specific percentages of semiconductor nanocrystals and inorganic capping agents may vary between different types of photocatalytic capped colloidal nanocrystal.

One embodiment, of the method 100 to substitute an organic capping agent on semiconductor nanocrystals with an inorganic capping agent may be illustrated when CdSe is capped with a layer of organic capping agent and is soluble in non-polar or organic solvents such as hexane. Inorganic capping agent, Sn₂Se₆²⁻, is soluble in polar solvents such as DMSO. DMSO and hexane are appreciably immiscible, however. Therefore, a hexane solution of CdSe floats on a DMSO solution of Sn₂Se₆²⁻. Within a short time, after combining the two solutions (about 10 minutes), the color of the hexane solution fades due to the CdSe. At the same time, the DMSO layer becomes colored as the organic capping agents are displaced by the inorganic capping agents. The resulting surface-charged semiconductor nanocrystals are then soluble in a polar DMSO solution. The uncharged organic capping agent is preferably soluble in the non-polar solvent and may be thereby physically separated, from the semiconductor nanocrystal, using a separation funnel. In this manner, organic capping agents from the organic capped semiconductor nanocrystals are removed. CdSe and Sn₂Se₆²⁻ may be obtained from Sigma-Aldrich.

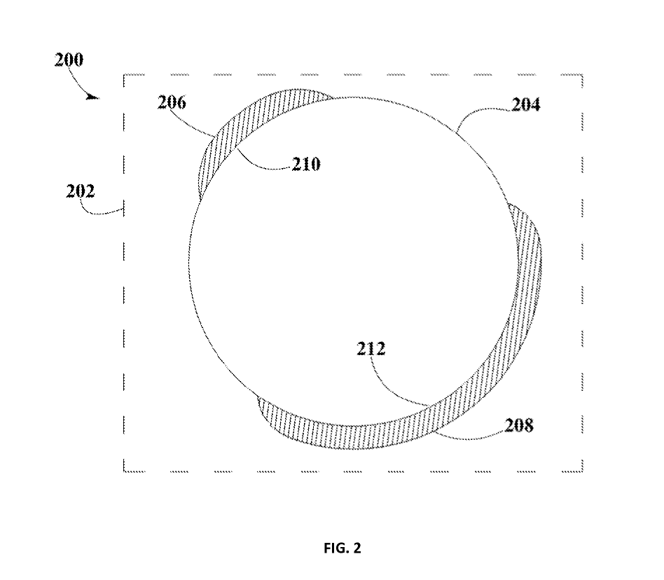

FIG. 2 depicts sphere configuration 200 of photocatalytic capped colloidal nanocrystal 202 that may include a single semiconductor nanocrystal 204 capped with first inorganic capping agent 206 and second inorganic capping agent 208. Single semiconductor nanocrystal 204 shown in this embodiment may include face A 210 and face B 212; the bond strength of organic capping agent to face A 210 may be twice that of the bond strength to face B 212. Organic capping agents on face B 212 may be preferably exchanged when employing method 100 for forming photocatalytic capped colloidal nanocrystals 202 described above. Isolation and reaction of this intermediate species, having organic and inorganic capping agents 108, with a second inorganic capping agent 208 may produce a photocatalytic capped colloidal nanocrystal 202 with a first inorganic capping agent 206 on face B 212 and a second inorganic capping agent 208 on face A 210. Alternatively, the preferential binding of inorganic capping agents 108 to specific single semiconductor nanocrystal 204 faces may yield the same result from a single mixture of multiple inorganic capping agents 108.

In another embodiment, single semiconductor nanocrystal 204 may be PbS quantum dots, with SnTe₄⁴⁻ used as first inorganic capping agent 206 and AsS₃³⁻ used as second inorganic capping agent 208, therefore forming a photocatalytic capped colloidal nanocrystals 202 represented as PbS.(SnTe₄;AsS₃).

Another aspect of the disclosed method 100 is the possibility of a chemical reactivity between first inorganic capping agent 206 and second inorganic capping agent 208. For example, a first inorganic capping agent 206 bound to the surface of a semiconductor nanocrystal 106 may react with a second inorganic capping agent 208. As such, method 100 may also provide for the synthesis of photocatalytic capped colloidal nanocrystals 202 that could not be selectively made from a solution of semiconductor nanocrystals 106 and inorganic capping agents. The interaction of the first inorganic capping agent 206 with semiconductor nanocrystals 106 may control both the direction and scope of the reactivity of first inorganic capping agent 206 with second inorganic capping agent 208. Furthermore, method 100 may control the specific areas where first inorganic capping agent 206 may bind to the semiconductor nanocrystal 106. The result of the addition of a combined inorganic capping agent capping to a semiconductor nanocrystal 106 by other methods may produce a random arrangement of the combined inorganic capping agent on semiconductor nanocrystal 106.

In addition, the shape of semiconductor nanocrystals 106 may improve photocatalytic activity of semiconductor nanocrystals 106. Changes in shape may expose different facets as reaction sites and may change the number and geometry of step edges where reactions may preferentially take place.

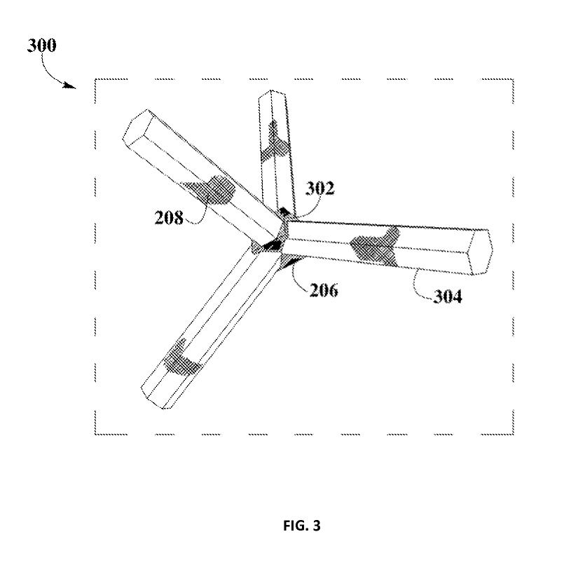

FIG. 3 depicts an embodiment of tetrapod configuration 300 of photocatalytic capped colloidal nanocrystal 202, that may include first semiconductor nanocrystal 302 that may be capped with first inorganic capping agent 206, and second semiconductor nanocrystal 304 that may be capped with second inorganic capping agent 208. As an example, photocatalytic capped colloidal nanocrystals 202 in tetrapod configuration 300 may include (CdSe;CdS).(Sn₂S₆⁴⁻;In₂Se₄²⁻), in which first semiconductor nanocrystal 302 may be (CdSe), coated with Sn₂S₆⁴⁻ as first inorganic capping agent 206, while second semiconductor nanocrystal 304 may be (CdS), capped with In₂Se₄²⁻ as second inorganic capping agent 208.

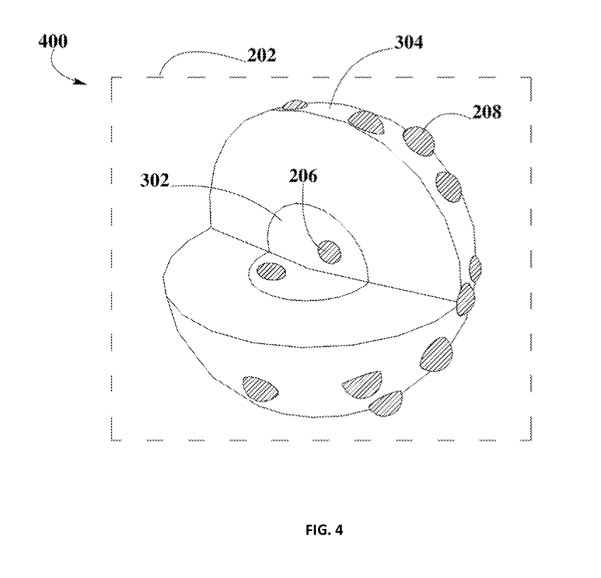

FIG. 4 depicts a illustrative embodiment of a core/shell configuration 400 of photocatalytic capped colloidal nanocrystals 202 that may include first semiconductor nanocrystal 302 and second semiconductor nanocrystal 304 that may be capped respectively with first inorganic capping agent 206 and second inorganic capping agent 208. As an example, photocatalytic capped colloidal nanocrystal 202 in core/shell configuration 400 may include (CdSe/CdS).Sn₂S₆⁴⁻, where first semiconductor nanocrystal 302 may be CdSe, while second semiconductor nanocrystal 304, may be CdS; Sn₂Se₆⁴⁻ may be both first inorganic capping agent 206 and second inorganic capping agent 208.

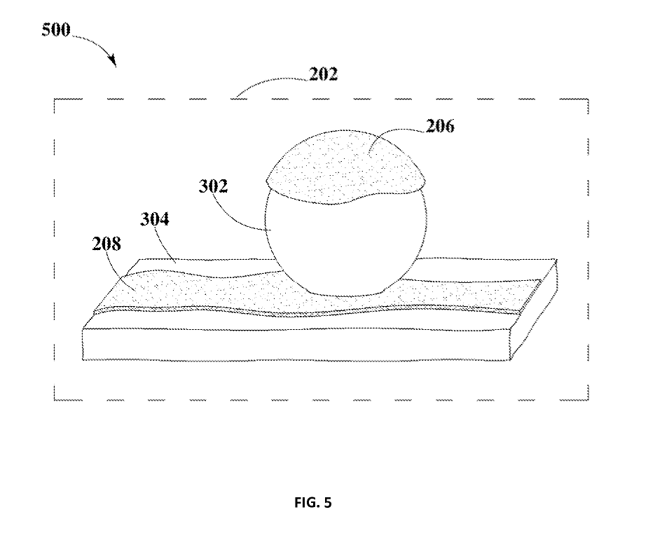

FIG. 5 shows another embodiment of a graphene configuration 500 of photocatalytic capped colloidal nanocrystal 202 comprising graphene oxide (GO). First semiconductor nanocrystal 302 is capped with first inorganic capping agent 206, while second semiconductor nanocrystal 304 is capped with second inorganic capping agent 208. In the present embodiment, graphene oxide may be used as second semiconductor nanocrystal 304.

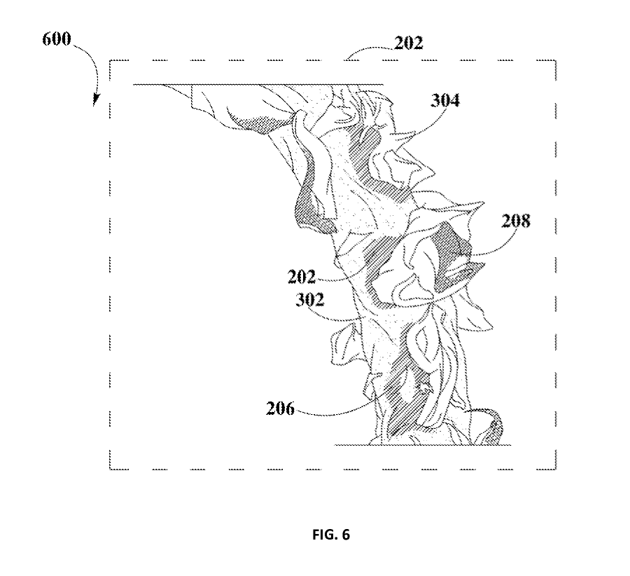

FIG. 6 shows an embodiment of a carbon nanotubes configuration 600 of photocatalytic capped colloidal nanocrystals 202, comprising first semiconductor nanocrystal 302 and second semiconductor nanocrystal 304 capped with first inorganic capping agent 206 and second inorganic capping agent 208, respectively. As an example, photocatalytic capped colloidal nanocrystal 202 in carbon nanotubes configuration 600 may include a carbon nanotube as first semiconductor nanocrystal 302, and graphene foliates as second semiconductor nanocrystal 304; TiO₂ may be first inorganic capping agent 206 and ReO₂ second inorganic capping agent 208, respectively. Depositing second semiconductor nanocrystal 304 graphene foliates along the length of first semiconductor nanocrystal 302 carbon nanotube may significantly increase the total charge capacity per unit of nominal area as compared to other carbon nanostructures. The graphene foliate density can vary as a function of deposition conditions (e.g. temperature and time) with their structure ranging from few layers of graphene (<10) to a thicker, more graphite-like structure.

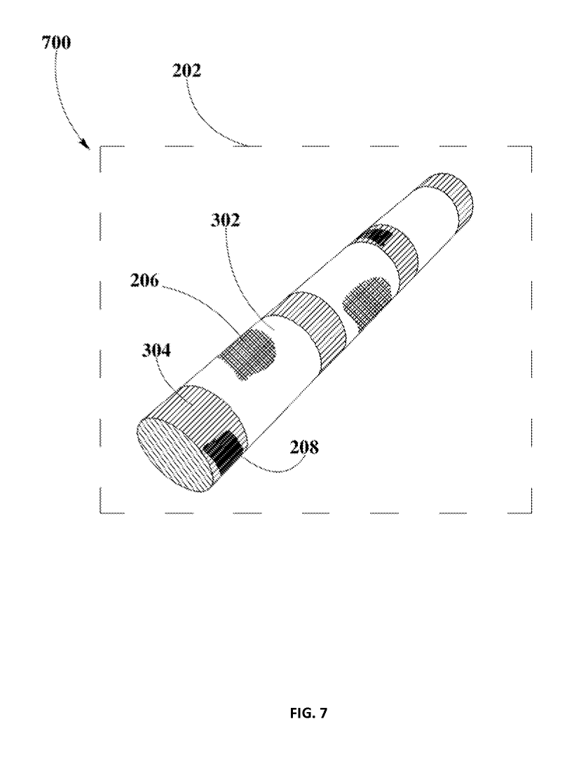

FIG. 7 depicts an embodiment including photocatalytic capped colloidal nanocrystals 202 in a nanorod configuration 700. The illustrated example contains three CdSe regions and four CdS regions as first semiconductor nanocrystal 302 and second semiconductor nanocrystal 304, respectively. In addition, first semiconductor nanocrystal 302 and second semiconductor nanocrystal 304 are capped with first inorganic capping agent 206 and second inorganic capping agent 208, respectively. Each of the three CdSe first semiconductor nanocrystal 302 regions is longer than each of the four CdS second semiconductor nanocrystal 304 regions. In other embodiments, the different regions with different materials may have the same or different lengths, and there can be any suitable number of different regions. The number of segments per nanorod in nanorod configuration 700 may generally increase by increasing the length of the nanorod or decreasing the spacing between like segments.

The band gap of photocatalytic capped colloidal nanocrystals 202 in nanorod configuration 700 may depend on the size of first semiconductor nanocrystal 302 and second semiconductor nanocrystal 304, matching the bulk material value for fully converted photocatalytic capped colloidal nanocrystals 202 in nanorod configuration 700 and shifting to higher energy in smaller segments due to quantum confinement. Such structures are of interest for photoactive materials that may result from methods in the present disclosure, where the sparse density of electronic states within photocatalytic capped colloidal nanocrystals 202 may lead to multiple exciton generation.

In nanorod configuration 700, the surface-to-volume ratio is higher than in sphere configuration 200, increasing the occurrence of surface trap-states. In segments exhibiting higher surface-to-volume ratios of first semiconductor nanocrystal 302 and second semiconductor nanocrystals 304, the increased delocalization of charge carriers may reduce the overlap of their wavefunctions, lowering the probability of charge carriers recombination. The delocalization of charge carriers should be particularly high within nanorod configurations 700, where charge carriers may be free to move throughout the length of the nanorod.

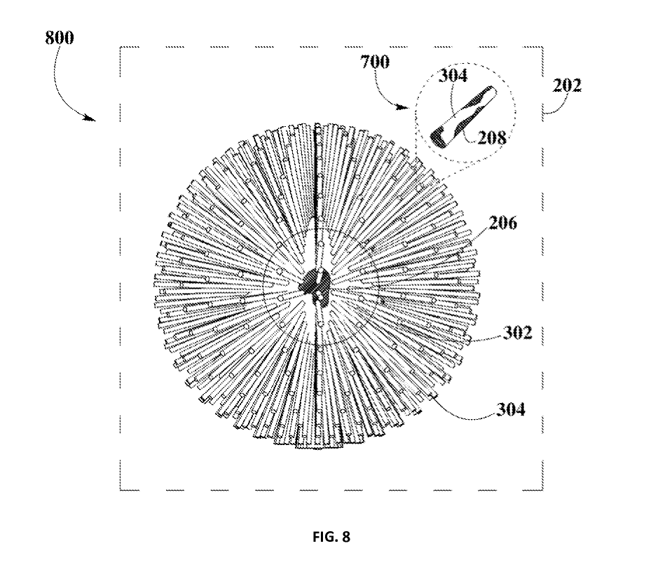

FIG. 8 shows an illustrative embodiment of a koosh nanoball configuration 800 of photocatalytic capped colloidal nanocrystals 202, which may include a Au/ZnO's heteroaggregate photocatalytic capped colloidal nanocrystal 202. Accordingly, first semiconductor nanocrystal 302 may be surrounded by second semiconductor nanocrystals 304, both capped by first inorganic capping agent 206 and second inorganic capping agent 208, respectively. Individual segments of second semiconductor nanocrystals 304 may be formed in a nanorod configuration 700, which may provide for a high photocatalytic surface area. Controlled semiconductor nanocrystal 106 seeding strategies may be employed in order to form koosh nanoball configuration 800.

### Method of Deposition

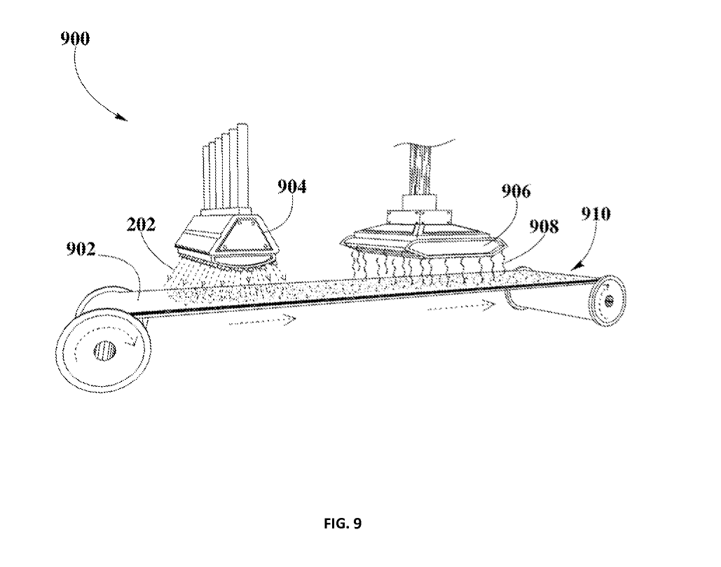

FIG. 9 depicts an embodiment of spraying deposition and annealing methods 900 that may be used to apply and thermally treat photocatalytic capped colloidal nanocrystals 202 composition on a substrate 902. Photocatalytic capped colloidal nanocrystal 202 disclosed here may be applied on suitable substrate 902, such as polydiallyldimethylammonium chloride (PDDA), employing a spraying device 904 during a period of time depending on desired thickness of photocatalytic capped colloidal nanocrystal 202 composition applied on substrate 902.

Yet another aspect of the current disclosure is the thermal treatment of the disclosed photocatalytic capped colloidal nanocrystals 202. Many first inorganic capping agents 206 or second inorganic capping agents 208 may be precursors to inorganic matrices. Therefore, low-temperature thermal treatment of first inorganic capping agents 206 and second inorganic capping agents 208 employing a convection heater 906 may provide a gentle method to produce crystalline films from photocatalytic capped colloidal nanocrystals 202. The thermal treatment of photocatalytic capped colloidal nanocrystals 202 may yield, for example, ordered arrays of semiconductor nanocrystals 106 within an inorganic matrix, hetero-alloys, or alloys. In at least one embodiment, convection heat 908 applied over photocatalytic capped colloidal nanocrystals 202 may reach temperatures less than about 350, 300, 250, 200, or 180° C.

As a result of spraying deposition and annealing methods 900, photoactive material 910 may be formed. Photoactive material 910 may then be cut into films to be used in energy conversion applications, including photocatalytic water splitting.

In addition to spraying deposition and annealing methods 900, other deposition methods of photocatalytic capped colloidal nanocrystals 202 may include sputter deposition, reverse Lang-muir-Blodgett technique, electrostatic deposition, spin coating, inkjet deposition, laser printing (matrices), and the like.

According to another embodiment, deposition on a substrate 902 may not be needed. Accordingly, photocatalytic capped colloidal nanocrystals 202 may be deposited into a crucible to be then annealed. The solid photocatalytic capped colloidal nanocrystals 202 may then be ground into particles and sintered to form a photoactive material 910 that may be deposited on a surface where it may adhere. In another embodiment, ground particles may be used directly as photoactive material 910.

According to another embodiment, deposition of the photocatalytic capped colloidal nanocrystals 202 composition on a substrate 902 may be achieved via a spin coating technique. Using spin coating technique, photocatalytic capped colloidal nanocrystals 202 composition may first be applied to a substrate 902, both of which may then be rapidly rotated to leave a thin layer of the photocatalytic capped colloidal nanocrystals 202 composition on substrate 902. Subsequently, photocatalytic capped colloidal nanocrystals 202 composition may then be dried, leaving a photoactive material 910 thin film. The wetting of substrate 902 by photocatalytic capped colloidal nanocrystals 202 composition is an important factor in achieving uniform thin films and the ability to apply photocatalytic capped colloidal nanocrystals 202 composition in a variety of different solvents enhances the commercial applicability of the disclosed spin coating technique. One method to achieve uniform wetting of substrate 902 surface is to match the surface free energy of substrate 902 with the surface tension of the liquid (colloidal particle solution). Theoretically, the perfect wetting of substrate 902 by photocatalytic capped colloidal nanocrystals 202 composition would yield a uniform photoactive material 910 thin film on substrate 902.

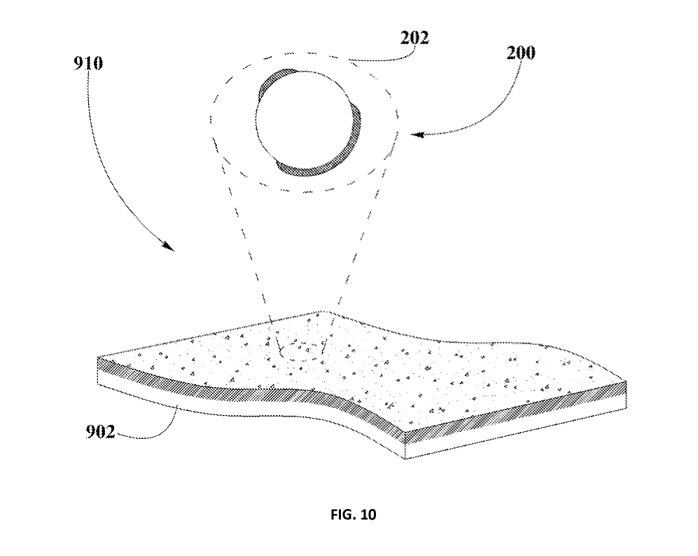

FIG. 10 illustrates photoactive material 910 including treated photocatalytic capped colloidal nanocrystals 202 composition in sphere configuration 200 over substrate 902. Photocatalytic capped colloidal nanocrystals 202 in photoactive material 910 may also exhibit tetrapod configuration 300, core/shell configuration 400, graphene configuration 500, carbon nanotubes configuration 600, nanorod configuration 700, koosh nanoball configuration 800, among others.

In order to measure the performance of photoactive material 910, techniques such as transmission electron microscopy (TEM), and energy dispersive X-ray (EDX), among others, may be utilized. Performance of photoactive material 910 may be related to light absorbance, charge carriers mobility and energy conversion efficiency.

### Charge Separation Process

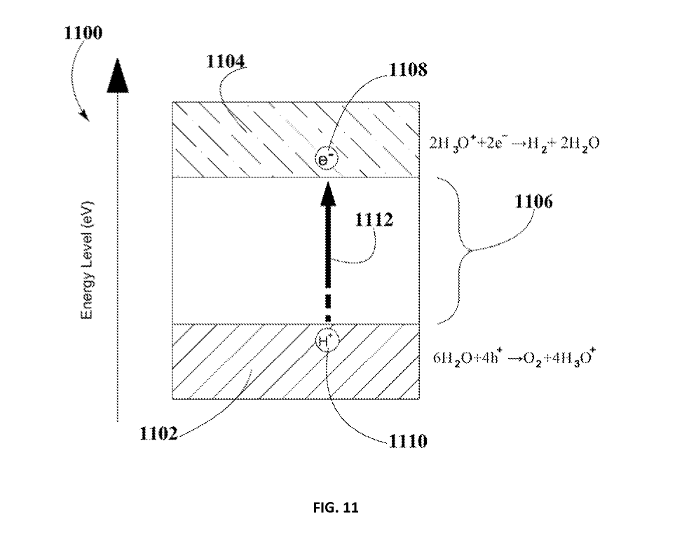

FIG. 11 shows charge separation process 1100 that may occur in the boundary between photoactive material 910 and water during a water splitting process. As shown, submerging photoactive material 910 into water in the presence of sunlight may lead to production of charge carriers that may be used in redox reactions for water splitting. The following discussion focuses on the band gap diagram of FIG. 11 to set out in detail the interaction among incident light and existing particles in this process.

The energy difference between valence band 1102 and conduction band 1104 of a semiconductor nanocrystal 106 is known as band gap 1106. Valence band 1102 refers to the outermost electron 1108 shell of atoms in semiconductor nanocrystals 106 and insulators in which electrons 1108 are too tightly bound to the atom to carry electric current, while conduction band 1104 refers to the band of orbitals that are high in energy and are generally empty. Band gap 1106 of semiconductor nanocrystals 106 should be large enough to drive photocatalytic reactions such as water splitting, but small enough to absorb a large fraction of light wavelengths. The manifestation of band gap 1106 in optical absorption is that only photons with energy larger than or equal to band gap 1106 are absorbed.

When light with energy equal to or greater than that of band gap 1106 makes contact with semiconductor nanocrystals 106 in photoactive material 910, electrons 1108 are excited from valence band 1102 to conduction band 1104, leaving holes 1110 behind in valence band 1102, a process triggered by photo-excitation 1112. Changing the materials and shapes of semiconductor nanocrystals 106 may enable the tuning of band gap 1106 and band-offsets to expand the range of wavelengths usable by semiconductor nanocrystal 106 and to tune the band positions for redox processes.

For a water splitting process, photo-excited electrons 1108 in semiconductor nanocrystals 106 should have a reduction potential greater than or equal to that necessary to drive the following reaction:

2H₃O⁺+2e⁻→H₂+2H₂O (1)

This reaction has a standard reduction potential of 0.0 eV vs. the standard hydrogen electrode (SHE), or standard hydrogen potential of 0.0 eV. Hydrogen (H₂) molecule in water may be reduced when receiving two photo-excited electrons 1108 moving from valence band 1102 to conduction band 1104. On the other hand, the photo-excited hole 1110 should have an oxidation potential greater than or equal to that necessary to drive the following reaction:

6H₂O+4h⁺→O₂+4H₃O⁺ (2)

That reaction may exhibit a standard oxidation potential of −1.23 eV vs. SHE. Oxygen (O₂) molecule in water may be oxidized by four holes 1110. Therefore, the absolute minimum band gap 1106 for semiconductor nanocrystal 106 in a water splitting process reaction is 1.23 eV. Given overpotentials and loss of energy for transferring the charges to donor and acceptor states, the minimum energy may be closer to 2.1 eV. The wavelength of the irradiation light may be required to be about 1010 nm or less, in order to allow electrons 1108 to be excited and jump over band gap 1106.

Electrons 1108 may acquire energy corresponding to the wavelength of the absorbed light. Upon being excited, electrons 1108 may relax to the bottom of conduction band 1104, which may lead to recombination with holes 1110 and therefore to an inefficient water splitting process. For efficient charge separation process 1100, reactions have to take place to quickly sequester and hold electrons 1108 and holes 1110 for use in subsequent redox reactions used for water splitting processes.

The process of FIG. 11 can be illustrated utilizing the tetrapod configuration 300 for photocatalytic capped colloidal nanocrystals 202 shown in FIG. 3. Here, the photoactive material 910 of FIG. 11 is represented by type II semiconductor nanocrystal heterostructure includes a base segment of a first semiconductor nanocrystal 302 and the branches are terminated with a second semiconductor nanocrystal 304. First semiconductor nanocrystal 302 material and second semiconductor nanocrystal 304 material are selected so that, upon photo-excitation 1112, one charge carrier (i.e. electron 1108 or hole 1110) is substantially confined to the core and the other carrier is substantially confined to the branches.

Two scenarios are possible in this configuration. In one example, conduction band 1104 of first semiconductor nanocrystal 302 may be at a higher energy than conduction band 1104 of second semiconductor nanocrystal 304 and valence band 1102 of first semiconductor nanocrystal 302 may be at a higher energy than valence band 1102 of second semiconductor nanocrystal 304. Alternatively, conduction band 1104 of first semiconductor nanocrystal 302 may be at a lower energy than conduction band 1104 of second semiconductor nanocrystal 304 and valence band 1102 of first semiconductor nanocrystal 302 may be at a lower energy than valence band 1102 of second semiconductor nanocrystal 304. These band alignments may make spatial separation of charge carriers, energetically favorable upon photo-excitation 1112.

A preferred embodiment of the process 1100 employs semiconductor nanocrystals 106 having type II heterostructures. These semiconductors have advantageous properties over type I heterostructures that may enhance the spatial separation of charge carriers. In some semiconductor nanocrystals 106 having type II heterostructures, the effective band gap 1106, as measured by the difference in the energy of emission and energy of the lowest absorption features, can be smaller than band gap 1106 of either of the two semiconductor nanocrystals 106 making up photocatalytic capped colloidal nanocrystals 202. By selecting particular first semiconductor nanocrystal 302 materials and second semiconductor nanocrystal 304 materials, and varying thicknesses of semiconductor nanocrystals 106 materials, photocatalytic capped colloidal nanocrystals 202 having type II heterostructures can absorb emission wavelengths, such as infrared wavelengths and near infrared wavelengths, providing for more efficient light extraction for water splitting processes and other photocatalytic processes employing photoactive material 910.

In an alternative implementation, semiconductor nanocrystal 106 in photoactive material 910 may be capped with first inorganic capping agent 206 and second inorganic capping agent 208 as a reduction photocatalyst and an oxidative photocatalyst, respectively. Following photo-excitation 1112 to conduction band 1104, electron 1108 can quickly move to the acceptor state of first inorganic capping agent 206 and hole 1110 can move to the donor state of second inorganic capping agent 208, preventing recombination of electrons 1108 and holes 1110. First inorganic capping agent 206 acceptor state and second inorganic capping agent 208 donor state lie energetically between the band edge states and the redox potentials of the hydrogen and oxygen producing half-reactions. The sequestration of the charges into these states may also physically separate electrons 1108 and holes 1110, in addition to the physical charge carriers separation that occurs in the boundaries between individual semiconductor nanocrystals 106. Being more stable to recombination in the donor and acceptor states, charge carriers may be efficiently stored for use in redox reactions required for energy conversion applications, including water splitting.

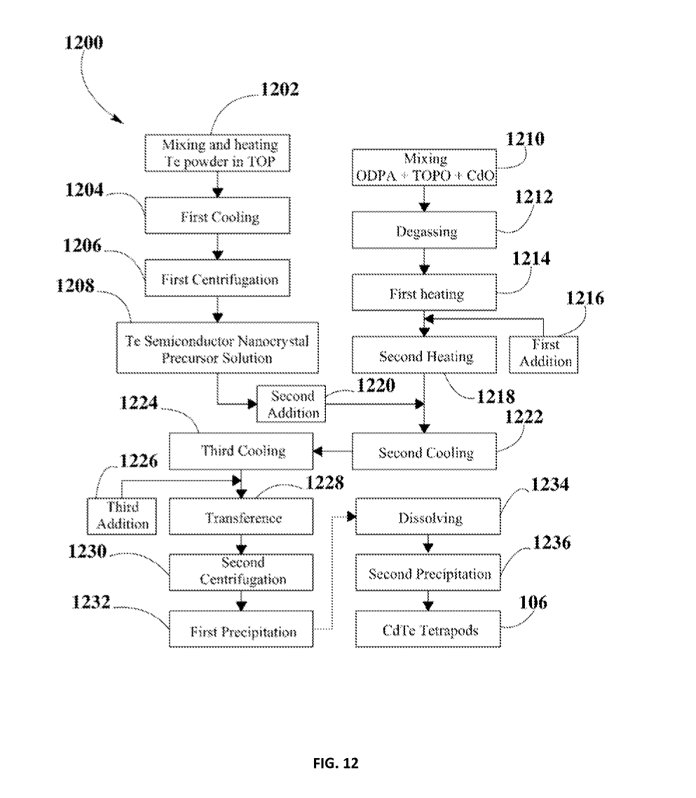

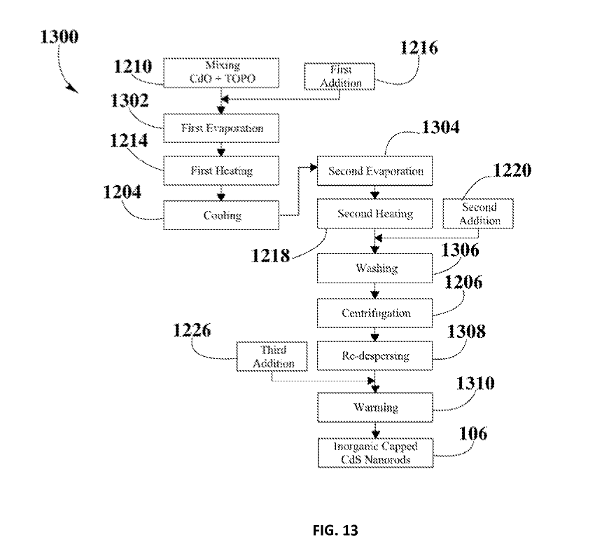

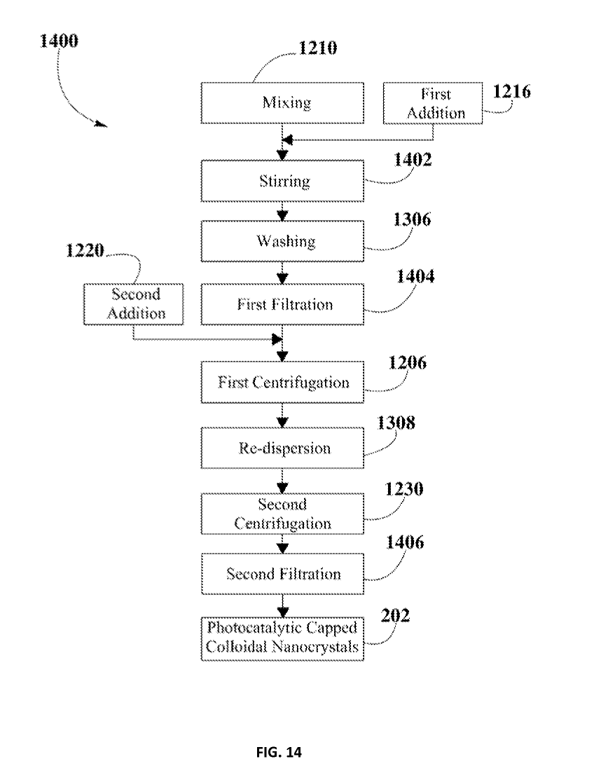

FIGS. 12-14 depict methods that may be used to produce different structures that may be suitable for use in connection with the present disclosure. In FIG. 12 an embodiment of the method 100 synthesizes CdTe tetrapods, where semiconductor nanocrystals 106 in tetrapod configuration 300 may be formed. FIG. 13 represents another embodiment of method 100, where semiconductor nanocrystals 106, here formed as CdS nanorods 700 may be formed. Finally, in FIG. 14 is a method 1400 forms CdSe/as photocatalytic capped colloidal nanocrystals.

### Examples

Example #1 is a method for synthesizing CdTe tetrapods 1200 as shown in FIG. 12, representing an embodiment of method 100.

### 1. Materials

Cadmium oxide (CdO) (99.99+%), Tellurium (Te) (99.8%, 200 mesh), and tri-n-octylphosphine oxide (C₂₄H₅₁OP or TOPO, 99%) may be purchased from Sigma-Aldrich. n-Octadecylphosphonic acid (C₁₈H₃₉O₃P or ODPA, 99%) may be purchased from Oryza Laboratories, Inc. Trioctylphosphine (TOP) (90%) may be purchased from Fluka. All solvents used are anhydrous, may be purchased from Sigma-Aldrich, and may be used without any further purification.

### 2. Synthesis of CdTe Tetrapods

All manipulations may be performed using standard air-free techniques. The Cd/Te molar ratio may be varied from about 1:1 to about 5:1, and the Cd/ODPA molar ratio may be varied from about 1:2 to about 1:5. Method for synthesizing CdTe tetrapods 1200 may begin by mixing and heating 1202, whereby tellurium powder in TOP (concentration of Te 10 wt. %) is mixed for 30 minutes at about 250° C. Subsequently in first cooling 1204, the mixture of Te in TOP may be cooled to room temperature and may undergo first centrifugation 1206 to remove any remaining insoluble particles and obtain Te semiconductor nanocrystal precursor 1208 solution. In mixing 1210, ODPA, TOPO, and semiconductor nanocrystal precursor 1208 CdO may be mixed and, in degassing 1212, the mixture may be degassed at about 120° C. for about 20 minutes in a 50 ml three-neck flask connected to a Liebig condenser. Subsequently in first heating 1214, the mixture including ODPA, TOPO, and CdO may be heated slowly under Ar until the CdO decomposes and the solution turns clear and colorless. Afterwards, in first addition 1216, 1.5 g of trioctyl phosphine (TOP) may be added, followed by second heating 1218, where the mixture may be heated to about 320° C. Following second heating 1218, Te semiconductor nanocrystal precursor 1208 solution may be injected quickly into the mixture of ODPA, TOPO and CdO during second addition 1220.

Following the process, in second cooling 1222, temperature is dropped to about 315° C. and is maintained throughout the synthesis. In third cooling 1224, all synthesis in the mixture including ODPA, TOPO, and CdO may be stopped by removing the heating mantle and rapidly cooling down to about 70° C. After third cooling 1224, in third addition 1226, 3-4 ml anhydrous toluene may be added to the flask containing the mixture, and may be transferred to an Ar drybox during transference 1228.

Following the process, in second centrifugation 1230, dispersion including ODPA, TOPO, and CdO in toluene, is centrifuged and later in first precipitation 1232, the minimum amount of anhydrous methanol may be used to precipitate semiconductor nanocrystals 106. As a result, potential co-precipitation of the Cd-phosphonate complex may be prevented. In dissolving 1234, the precipitated semiconductor nanocrystals 106 may be re-dissolved twice in toluene and, followed by second precipitation 1236, where the precipitated semiconductor nanocrystals 106 may be precipitated again with methanol to form CdTe semiconductor nanocrystals 106 in tetrapod configuration 300 which may finally be stored in the Ar drybox. All resulting CdTe semiconductor nanocrystals 106 in tetrapod configuration 300 are readily soluble in solvents such as chloroform or toluene.

Example 2 a method for synthesizing CdS nanorods 1300 as shown in FIG. 13, representing an embodiment of method 100.

### 1. Materials

Cadmium oxide (CdO, 99.99%), silver nitrate (AgNO₃, 99+%), sulfur (99.99%), toluene (anhydrous 99%), and nonanoic acid (96%) may be purchased from Sigma-Aldrich. Isopropanol may be purchased from Fisher Scientific and methanol may be purchased from Fisher Scientific or EMD Chemicals. Tetradecylphosphonic acid (TDPA) and octadecylphosphonic acid (ODPA) may be purchased from Polycarbon Industries (PCI Synthesis, 9 Opportunity Way, Newburyport, Mass. 01950, 978-463-4853). Trioctylphosphine oxide (TOPO, 99%) may be purchased from Acros Organics. Tetrachloroethylene may be obtained from Kodak. Trioctylphosphine (TOP, 97%) may be purchased from Strem Chemicals. Trioctylphosphine sulfide (TOPS) may be prepared by mixing TOP and sulfur together in a 1:1 molar ratio in a glovebox followed by stirring at room temperature for more than 36 hours.

### 2. Synthesis of CdS Nanorods

In order to synthesize CdS nanorods, CdS nanorods dimensions may be 5.3±0.4×50±10.5 nm. The reactions may be performed using standard Schlenk line techniques. Method for synthesizing CdS nanorods 1300 may start at mixing 1210, whereby 210 mg of semiconductor nanocrystal precursors 1208 CdO and 2.75 g of TOPO may be placed in a 25 ml, 3-neck flask. Subsequently, in first addition 1216, 0.80 g of ODPA and 0.22 g of TDPA are added. During first evaporation 1302, the contents of the flask may be evaporated at about 120° C. for more than 30 minutes, and then in first heating 1214, the flask may be heated to about 320° C. under argon for about 15 minutes to allow the complexation of cadmium with phosphonic acid. In cooling 1204, the reaction mixture may be cooled to about 120° C., followed by second evaporation 1304, where contents of flask may be evaporated for about 1 hour to remove water produced during the complexation. In second heating 1218, the reaction mixture in the flask may be heated up to about 320° C.

Following the process, in second addition 1220, 1.3 g of TOPS may be injected and semiconductor nanocrystals 106 in nanorod configuration 700 may be grown for 85 minutes at about 315° C. Subsequently, toluene may be added to the reaction mixture in second addition 1220, and semiconductor nanocrystals 106 solution may be opened to air. Then, during washing 1306, grown semiconductor nanocrystals 106 may be washed several times by adding equal amounts of nonanoic acid and isopropanol—to induce flocculation—and, in centrifugation 1206, CdS semiconductor nanocrystals 106 are precipitated. Afterwards, during re-dispersing 1308, the precipitated semiconductor nanocrystals 106 may be re-dispersed in fresh toluene. The previous reaction may produce some branched structures (i.e., bipods, tripods, and tetrapods) along with CdS semiconductor nanocrystals 106. However, the branched structures may be removed during washing 1306, as the branched CdS semiconductor nanocrystals 106 do not flocculate as easily as the CdS semiconductor nanocrystals 106 and thus stay in supernatant. In order to add inorganic capping agent 108 to CdS semiconductor nanocrystals 106, during third addition 1226, CdS semiconductor nanocrystals 106 in toluene may be added to a solution of toluene and AgNO₃ in methanol at about ⁻66° C. in air. Then, during warming 1310, the reaction vials may be capped after adding the CdS semiconductor nanocrystals 106 solution and may be allowed to warm to room temperature for a period of at least 30 minutes in order to obtain CdS semiconductor nanocrystals 106 in nanorod configuration 700. The amounts used for a typical reaction to produce the CdS.Ag superlattices may be 2.0 ml of toluene, 0.6 ml of a 1.2×10⁻³ M AgNO₃ solution in methanol, 0.3 ml methanol, and 0.2 ml of CdS semiconductor nanocrystals 106 in toluene (0.2 mL of the CdS toluene solution diluted to 2.2 ml with toluene).

Example 3 is a method for forming CdSe/ZnS.Sn2S6- 1400 as shown in FIG. 14, representing an embodiment of method 100.

### 1. Materials

Ammonium hydroxide (NH₄OH), ammonium tin sulfide (NH₄)₄Sn₂S₆, cadmium selenide (CdSe), zinc sulfide (ZnS), hexane (anhydrous 99%), toluene (anhydrous 99%), and acetronile (anhydrous 99.8%) may be purchased from Sigma-Aldrich. Polytetrafluoroethylene (PTFE) filter may also be purchased from Sigma-Aldrich.

### 2. Method of Forming CdSe/ZnS.Sn₂S₆ Photocatalytic Capped Colloidal Nanocrystals 202

Method for forming CdSe/ZnS.Sn2S6- 1400 may begin with mixing 1210, whereby, an aqueous NH₄OH solution (8 mL, 28-30% of NH₃) may be mixed with aqueous inorganic capping agent 108 precursors (NH₄)₄Sn₂S₆ (0.5 mL, ^{˜}0.1 M). In first addition 1216, an organic mixture including hexane (6 mL) and toluene solution of about 6.5-nm CdSe/ZnS as first semiconductor nanocrystal 302 and second semiconductor nanocrystal 304, respectively, (1 mL, ^{˜}25 mg/mL) may be added to the same vial containing the aqueous mixture including NH₄OH and (NH₄)₄Sn₂S₆. Following the process, in stirring 1402, the aqueous mixture with organic mixture may be vigorously stirred for about 1 hour, until the phase transfer of semiconductor nanocrystals 106 from the organic phase into aqueous phase is completed. Then, during washing 1306, the mixture in aqueous phase may be washed 3 times with hexane, followed by first filtration 1404, where the aqueous mixture may be filtered through a 0.45-μm PTFE filter. Subsequently, in second addition 1220, in order to separate the excess amount of inorganic capping agents 108, a minimal amount of acetonitrile may be added to precipitate photocatalytic capped colloidal nanocrystals 202, which may be collected during first centrifugation 1206.

During re-dispersion 1308, precipitated photocatalytic capped colloidal nanocrystals 202 may be re-dispersed in water and may later undergo second centrifugation 1230 and second filtration 1406 to remove traces of insoluble materials and obtain photocatalytic capped colloidal nanocrystals 202.

I claim:

1. A photocatalytic capped colloidal nanocrystal, comprising
a first semiconductor nanocrystal, formed as a carbon nanotube;
a second semiconductor nanocrystals, including graphene foliates deposited on the first nanocrystal;
a first inorganic capping agent overlying at least a portion of the first nanocrystal;
a second inorganic capping agent overlying at least a portion of the second nanocrystal.

2. The photocatalytic capped colloidal nanocrystal of claim 1, wherein the first inorganic capping agent is TiO₂.

3. The photocatalytic capped colloidal nanocrystal of claim 1, wherein the first inorganic capping agent is ReiO₂.

4. A photocatalytic capped colloidal nanocrystal, comprising
a plurality of first and second semiconductor nanocrystals, formed as a nanorod, first semiconductor nanocrystal nanorod regions alternating with second semiconductor nanocrystal nanorod regions;
a first inorganic capping agent overlying at least a portion of the first semiconductor nanocrystal;
a second inorganic capping agent overlying at least a portion of the second semiconductor nanocrystal.

5. The photocatalytic capped colloidal nanocrystal of claim 4, wherein the first semiconductor nanocrystal is CdSe and the second semiconductor nanocrystal is CdS.

6. The photocatalytic capped colloidal nanocrystal of claim 4, wherein each first semiconductor nanocrystal region is longer than each second semiconductor nanocrystal region.

7. A photocatalytic capped colloidal nanocrystal, comprising
a first semiconductor nanocrystal, generally spherical in form;
a plurality of second semiconductor nanocrystals, each second semiconductor nanocrystal formed as a nanorod extending radially outward from the first semiconductor nanocrystal;
a first inorganic capping agent overlying at least a portion of the first semiconductor nanocrystal;
a second inorganic capping agent overlying at least a portion of each second semiconductor nanocrystal.

8. The photocatalytic capped colloidal nanocrystal of claim 7, wherein the first semiconductor nanocrystal is a heteroaggregate photocatalytic capped colloidal nanocrystal of AuZnO.
